(19) United States
(12) Patent Application Publication
(10) Pub. No.: US 2005/0000413 A1
(43) Pub. Date: Jan. 6, 2005

(54) Coating apparatus

(76) Inventors: Takayuki Ohno, Toyokawa (JP); Akihito Fujishiro, Nagoya (JP)

Correspondence Address: WENDEROTH, LIND & PONACK, L.L.P., 2033 K STREET N. W., SUITE 800, WASHINGTON, DC, 20006-1021, US

(21) Appl. No.: 10/880,517

(22) Filed: Jul. 1, 2004

(30) Foreign Application Priority Data
Jul. 2, 2003 (JP) 2003-190458

(51) Int. Cl. B05C 11/02; B05C 13/00

(52) U.S. Cl. 118/52; 118/13

(57) ABSTRACT

A coating apparatus is described for coating the surface of a center or core of chewing gum with a sugarcoated layer. The apparatus includes a cylindrical fixed tub having a bottom and an inner fixed circumferential wall. A rotating plate is mounted on the bottom of the fixed tub so as to be coaxial with the fixed tub. The surfaces of the rotating plate and the fixed tub are determined to allow the smooth transfer of the gum centers from the rotating plate to the inner fixed circumferential wall of the fixed tub. The inner fixed circumferential wall of the fixed tub is configured with ridges so as to reduce the tendency of the gum centers to adhere to the wall and to increase the coating area and the drying area of the gum centers.

### BACKGROUND OF THE INVENTION

1. Field of the Invention

This invention relates to a coating apparatus for coating a surface of center or core of chewing gum or the like with a sugarcoated layer or the like.

2. Description of the Related Art

There have conventionally been provided chewing gums or toffees having surfaces formed with sugar coated layers. For example, a pan coating apparatus such as shown in JP-U-45-2956-B is used to form the above-described sugarcoated layers.

A center or core of chewing gum is put into a coating tub. Then the coating tub is rotated at low speeds. The whole chewing gum center forms a mass which is generally semicircular in sectional view by the chewing gum center scraping or sliding in the coating tub. A surface layer of the chewing gum center slips or slides down from an upper end of the mass toward a lower end of the mass. Once the chewing gum center slips down and is pushed against the bottom of the mass, the chewing gum center is subsequently caused to rise along the inner circumferential wall of the coating tub. The chewing gum center slips again down toward the lower end of the mass and the process is repeated, causing the chewing gum center to be re-circulated in the coating tub.

A predetermined amount of syrup is added into the coating tub during the above-described movement or flow of the chewing gum centers. As a result, a sugarcoated layer is formed on the entire surface of the individual chewing gum centers due to the crystallization of the syrup, thereby completing the formation of a sugarcoated chewing gum.

In the foregoing method, however, the manner of movement or flowage of the chewing gum centers is not the same for each of the centers, due to the shape of the coating tub. Accordingly, the distribution of the chewing gum centers is not uniform throughout the coating tub. For example, the distance of movement differs between the middle of the center of the coating tub and an end of the center of the coating tub. Consequently, the sugar coating tends to be non-uniform. In view of this problem, the chewing gum centers are sometimes stirred up during the coating process or syrup is added to a part of the center of the coating tub where the sugar coating is insufficient. However, these procedures require specialized experience or skill in order to perform adequately.

Furthermore, only the surface layers of the chewing gum centers within the semicircular center flows are coated in the coating tub. Accordingly, an area of flowage or an area contributing to the coating of the chewing gum centers with syrup is small. Consequently, the resulting coating efficiency is relatively low.

Additionally, drying is carried out after the addition of syrup. However, the area containing the chewing gum centers exposed to the blow-drying of air is also small, whereupon the working efficiency of the coating process is further reduced. As a countermeasure, increasing the rotational speed of the coating tub is often proposed. However, as the increased centrifugal force presses the chewing gum center against the inner circumferential wall of the coating tub, there is an increased likelihood that the chewing gum centers adhere to the inner circumferential wall of the tub.

JP-7-232049-A discloses another coating apparatus which attempts to overcome the foregoing problems of the previous pan coating apparatus. The disclosed coating apparatus includes a coating tub constituted by a rotating plate and a fixed tub. In this case, the the mass of the centers does not form the aforesaid monotonous semicircular shape, but takes a conical shape and produces a vortex. As a result, a more uniform coating can be efficiently carried out.

However, the coating apparatus disclosed in JP-7-232049-A has the following problem. This coating apparatus is suitable for the granulation coating of powder and sphere shaped center pieces, but unsuitable for the coating of other shapes of center pieces having a large resistance to flow or motion, for example, square centerpieces with each square side not less than about 3 mm long and a thickness of not less than about 2 mm. In this case, as in the previous pan coating apparatus, the flow speed of the chewing gum centers across the coating material tends to be too slow. However, when the speed of the chewing gum centers flowing upward along the inner circumferential wall of the tub is reduced, the chewing gum centers adhere to the inner circumferential wall of the tub, thereby inhibiting the flowage or movement of the chewing gum centers.

### SUMMARY OF THE INVENTION

Therefore, an object of the present invention is to provide a coating apparatus which can improve the efficiency of the coating process.

To achieve this object, the present invention provides a coating apparatus comprising a cylindrical fixed tub, having a bottom and an inner fixed circumferential wall, and a rotating plate mounted on the bottom of the fixed tub so as to be coaxially aligned with the fixed tub and rotatable. The inner fixed circumferential wall of the fixed tub has a lower end formed with a circumferential arc transfer portion, through which an object to be coated smoothly moves from the rotating plate side toward the inner fixed circumferential wall of the fixed tub. In this construction, the inner rotating circumferential wall of the rotating plate includes a straight portion that is continuous or flush with the transfer portion of the fixed tub and has a linearly rising gradient toward the transfer portion. A line tangent to and continuous with the transfer portion substantially defines the straight portion.

In the above-described coating apparatus, the object to be coated is subjected to a centrifugal force upon the rotation of the rotating plate. Accordingly, the object is moved in part due to the centrifugal force toward the outer circumferential side along the straight portion. The object is further moved through the transfer portion to the inner fixed circumferential wall of the fixed tub. The object then rises along the inner fixed circumferential wall of the fixed tub. An upper portion of the surface layer of the object slides down toward the central interior of the coating tub. Therefore the object is re-circulated in the coating tub. Coating is substantially carried out during the sliding of the objects.

The arc transfer portion is provided so as to be continuous or flush to the inner fixed circumferential wall of the fixed tub. The transition from the flat, essentially horizontal floor of the rotating plate to the essentially vertical inner fixed circumferential wall of the fixed tub is accomplished by including an inclined straight section onto the rotating plate. The transfer portion is connected to the rotating plate side by the straight portion that is formed essentially by a line tangent to the transfer portion. As a result, the speed at which the object to be coated flows to the transfer portion is increased as compared with the case where the transfer portion is connected to the floor of the rotating plate side with an arc having the same or greater degree of curvature as that of the transfer portion (i.e., the transition from the floor of the rotating plate to the vertical fixed section has a straight portion as compared to a transition between the two made up of a single arc) . Consequently, the flowing speed or movement of the objects to be coated can be increased for a given rotational velocity and the working efficiency of the coating process can be improved. Further, the object to be coated can be inhibited from adhering to the inner fixed circumferential wall of the fixed tub due to the increase in the speed at which the objects rise along the inner fixed circumferential wall of the fixed tub.

In a preferred form, the straight portion forms an angle ranging from 40° to 55° to the horizontal plane. An experiment conducted by the inventor shows that this angular range is effective for increasing the flowing speeds of the objects to be coated.

In another preferred form, a lining of polyurethane resin is applied to the surfaces of the inner circumferential walls of the fixed tub and the rotating plate. Accordingly, even when the object to be coated collides against the inner circumferential wall of the fixed tub or the rotating plate, the object to be coated can be inhibited from damage (e.g., breakage, cracking, etc.) or generating excessive noise. Further, the centers or objects to be coated can easily tend to roll without slippage.

In another further preferred form, the inner fixed circumferential wall of the fixed tub has an upper end formed with a circumferential adhesion preventing portion. The adhesion preventing portion includes small concave and convex portions, inhibiting an object to be coated from adhering to the inner fixed circumferential wall of the fixed tub. Since the inner fixed circumferential wall is formed containing the small concave and convex portions, the contact area between the inner fixed circumferential wall of the fixed tub and the individual objects can be reduced. Therefore, the adhesion of the objects to be coated can be prevented or inhibited. Furthermore, multiple streaks, ridges, protrusions, cavities, recesses, or grooves, for example, extending in the flowing direction of the objects to be coated, may form the adhesion preventing portion. Consequently, sliding resistance can be reduced and smooth flowage or movement of the objects to be coated can be achieved.

In yet another further preferred form, a duct is provided for supplying drying air into the coating tub so that the objects to be coated are dried. The duct may have an open end located over the center pole of the interior of the rotating plate. Consequently, the drying air can be supplied uniformly to the objects to be coated in the coating tub.

### BRIEF DESCRIPTION OF THE DRAWINGS

Other objects, features and advantages of the present invention will become clear upon reviewing the following description of the embodiment with reference to the accompanying drawings, in which:

FIG. 1 is a perspective view of the coating apparatus in accordance with one embodiment of the present invention;

FIG. 2 is a sectional view of the coating tub of the coating apparatus;

FIG. 3 is an enlarged sectional view of one side of the inner circumferential wall of the coating tub;

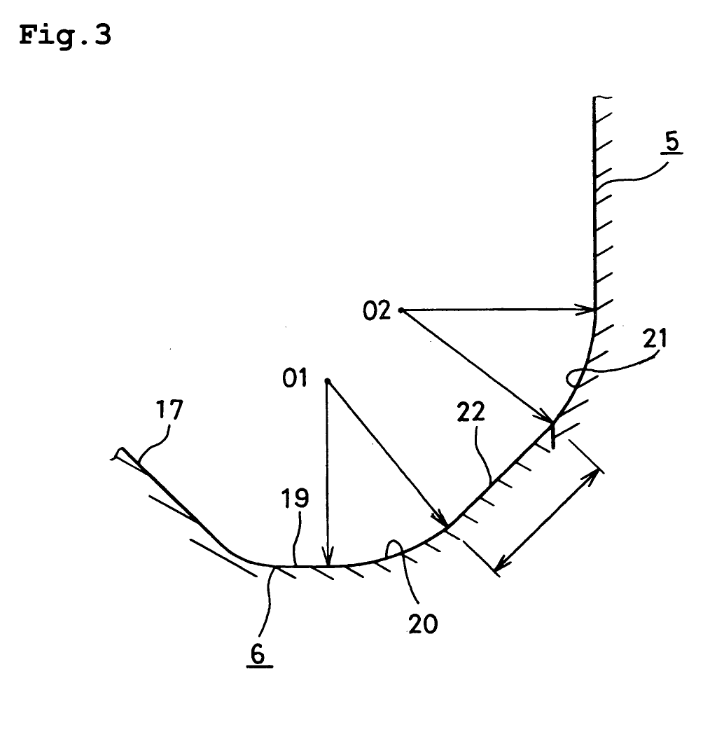

FIG. 4 is a partially broken perspective view of a typical chewing gum center as an object to be coated;

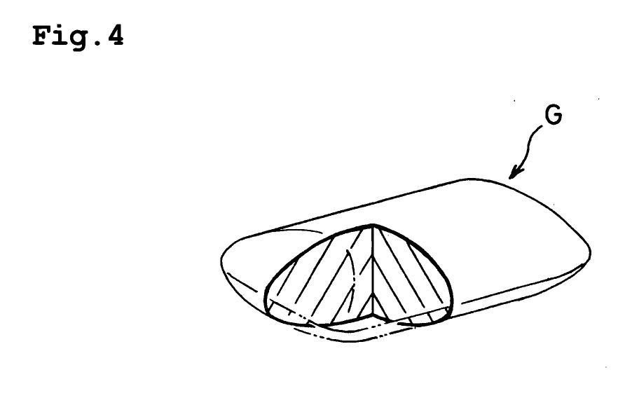

FIG. 5 is a sectional front view of the coating tub, showing the adhesion preventing portion; and

FIG. 6 is an enlarged sectional view of a connecting portion connecting a rotational shaft and the rotating plate.

### DETAILED DESCRIPTION OF THE INVENTION

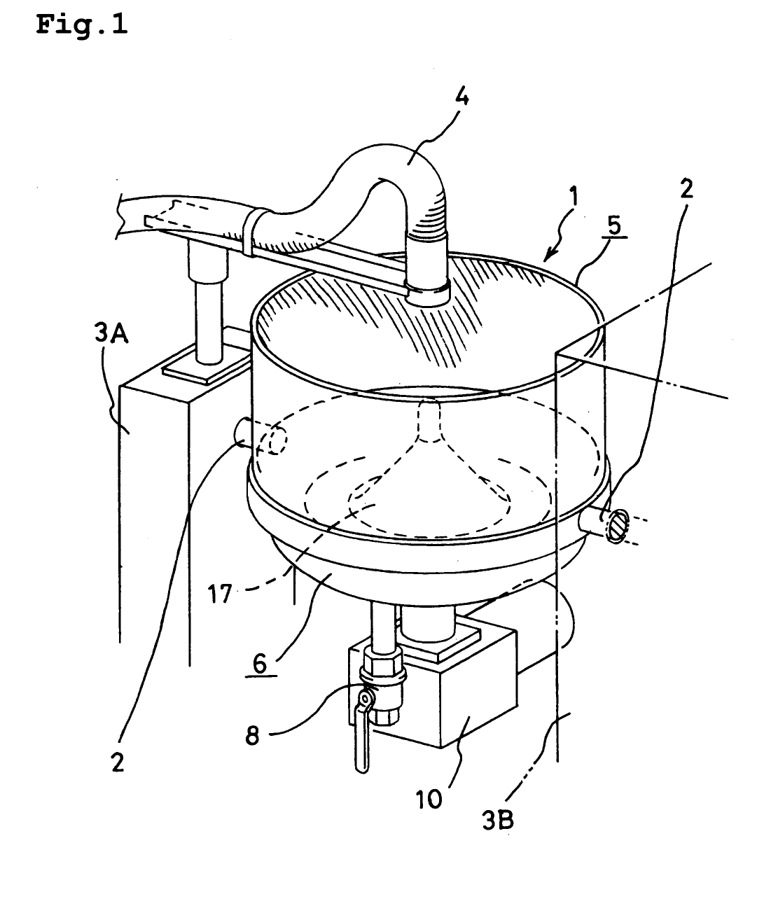

One embodiment of the present invention will be described with reference to the accompanying drawings. Referring to FIG. 1, the overall coating apparatus of the embodiment is shown. The coating apparatus comprises a cylindrical bottomed coating tub 1 having an upper opening. Two support shafts 2 protrude from opposite sides of an outer circumferential wall of the coating tub 1 respectively. Two support boxes 3A and 3B are provided so as to respectively correspond to the support shafts 2. Bearings (not shown) are provided in the support boxes 3A and 3B for rotatably supporting the support shafts 2. An electric motor (not shown) is provided in one of the support boxes 3A and 3B so that the coating tub 1 may be rotated a predetermined angle about the support shafts 2. As a result, objects to be coated can easily be placed into the coating tub 1 and finished coated products can be taken out of the coating tub 1 after the completion of the coating. A duct 4 has one of two ends located over the central interior of the coating tub 1 as shown in FIG. 1. The other end of the duct 4 is connected to a heated air source not shown. After the completion of the coating, duct 4 supplies drying air to the products.

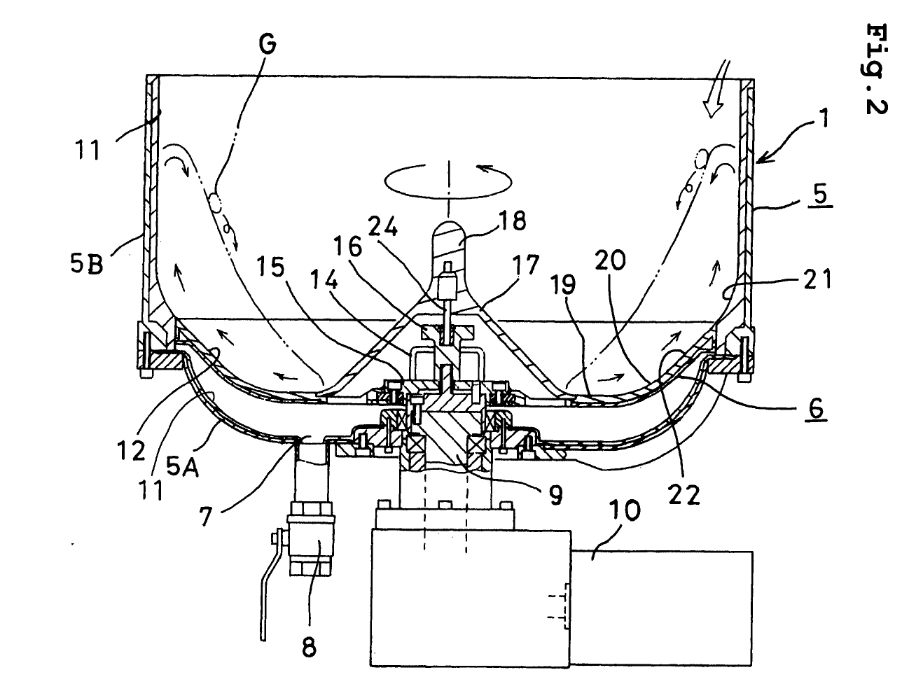

The coating tub 1 comprises a fixed tub 5 and a rotating plate 6. Rotating plate 6 is rotatably mounted on the bottom of the fixed tub 5. The fixed tub 5 may be made of metal and is formed into a cylindrical shape with an open upper end. More specifically, the fixed tub 5 includes a shallow dish-shaped bottom 5A. A body 5B is mounted to an outer circumferential edge of the bottom 5A by fastening devices, such as bolts, as shown in FIG. 2. A lining 11 of polyurethane resin is applied to surfaces of the bottom 5A and body 5B. The lining 11 applied to the bottom 5A has a primary purpose of corrosion protection. The lining 11 applied to the body 5B has a main purpose of preventing gum centers G, as objects to be coated, from being damaged or causing excessive noise.

The bottom 5A has a drain hole 7 in which a lever-operated valve 8 is provided. A vertically extending rotating shaft 9 is supported at the central portion of the bottom 5A. The rotating shaft 9 is coupled to the rotating plate 6, as will be described later. The rotating shaft 9 has a lower end connected to a drive motor 10 so that the rotating plate 6 may be rotated at high speeds.

The rotating plate 6 is disposed below the body 5B of the fixed tub 5, so as to be coaxially aligned with the fixed tub 5. A predetermined space is defined between the bottom 5A of the fixed tub 5 and the rotating plate 6. The rotating plate 6 may be made of metal, similar to the fixed tub 5. A polyurethane lining 12 is applied to an inner rotating circumferential surface of the rotating plate 6. The lining 12 has the same thickness as the lining 11 applied to the surfaces of the body SB of the fixed tub 5. A small gap is defined between the outer circumferential edge of the lining 12 (applied to the rotating plate 6) and the lower edge of the lining 11 (applied to the body 5B of the fixed tub 5) so that the rotating plate 6 is free to rotate.

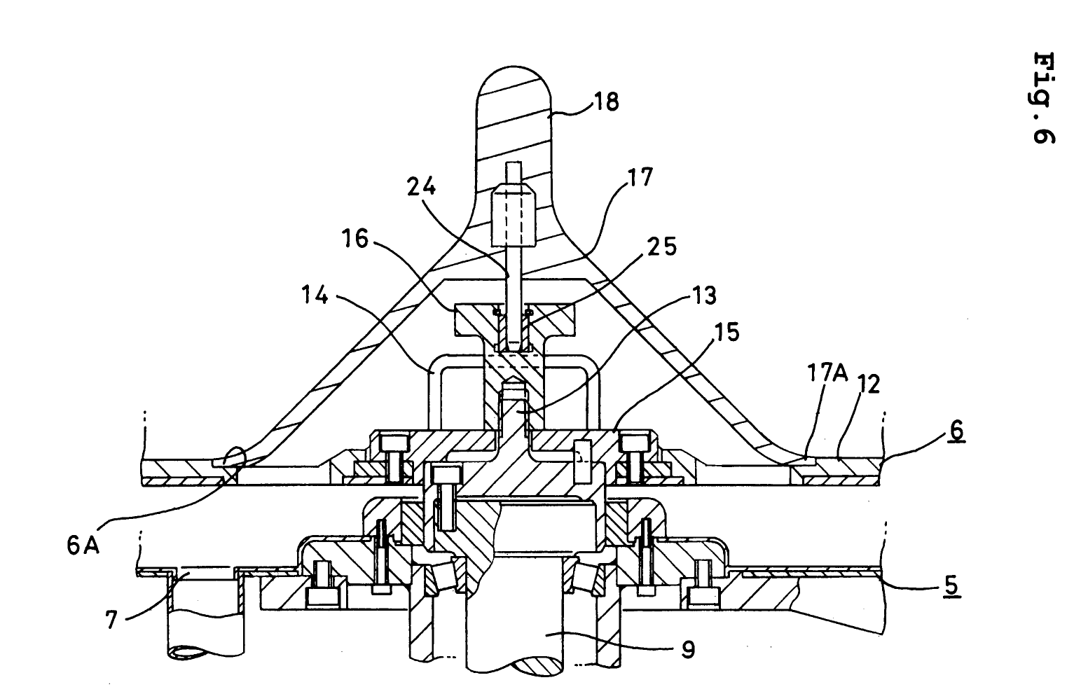

The rotating plate 6 is detachably mounted on the rotating shaft 9. More specifically, a connecting screw shaft 13 protrudes from an upper end of the rotating shaft 9, as shown in FIG. 6. A connecting disc 15 is disposed on the central bottom of the rotating plate 6. The connecting disc 15 is provided with a pair of grips 14. The connecting disc 15 has a centrally formed through hole through which the screw shaft 13 extends. A generally T-shaped lock bolt 16 is engaged with the screw shaft 13 protruding above the connecting disc 15, whereupon torque is transmitted through the rotating shaft 9 to the rotating plate 6 side. When the lock bolt 16 is unfastened and removed, the rotating plate 6 is disconnected from the rotating shaft 9. The operator grasps the grips 14 in order to lift up the rotating plate 6, detaching the rotating plate 6 from the fixed tub 5.

A center pole 17 is disposed in the central interior of the rotating plate 6 in order to cover a portion of the tub connected to the shaft 9. The center pole 17 is made from a synthetic resin and formed into a generally conical shape. The center pole 17 has an insertion shaft 24 extending downward from an inner central portion thereof, so that the shaft 24 is inserted into a sleeve 25 embedded in the top of the lock bolt 16. Further, the center pole 17 has a top formed with a protrusion 18 for detachment thereof and a root portion extending horizontally to serve as a seat edge 17A. The center pole 17 further has an inclined face, preferably with an inclination set at about 45°. The inclined face receives drying air from the duct 4, reflecting the drying air so that a surface layer of the gum center G is subjected to the drying air while the gum center G is in a vortex type of motion. The inclination angle of the center pole 17 effectively ranges from about 30° to 60°. When the angle of inclination is smaller than 30°, the loss of the drying air becomes too large when the drying air transfers from the protrusion 18 to the incline face, where upon smooth flow of drying air is prevented. Furthermore, when the inclination is larger than 60°, the height of the center pole 17 is excessively increased, and the loss of the drying air becomes too large when the drying air flows from the inclined face to the bottom of the rotating plate 6.

The bottom shape of the rotating plate 6, or the inner rotating circumferential wall, will now be described. The bottom of the rotating plate 6 includes a central portion formed with a ring-shaped stepped face 6A, into which the center pole 17 is fitted. The bottom of the rotating plate 6 further includes an annular horizontal portion 19 formed circumferentially outside of the stepped face 6A and having a predetermined width. Additionally, an arc portion 20 is formed to be continuous with an outer circumferential edge of the horizontal portional 9. The arc portion 20 has a predetermined radius of curvature. The inner fixed circumferential wall of the fixed tub 5 has an arc shaped transfer portion 21 formed on the lower end thereof. The transfer portion 21 may have the same radius of curvature as the arc portion 20. The rotating plate 6 includes a straight portion 22 connecting the arc portion 20 and the transfer portion 21. The straight portion 22 forms a line tangential to both the arc portion 20 and the transfer portion 21. The straight portion 22 has an upward gradient and preferably forms an angle of 45° with a horizontal plane. The inventor has experimentally confirmed that the range of angles the straight portion 22 forms with the horizontal plane are desirably between and including 40° to 55°. When the angle of the straight portion 22 is smaller than 40°, the angle between the inner fixed circumferential wall of the fixed tub 5 and the straight portion 22 inevitably becomes too pronounced. The force pushing the gum centers G up is reduced, whereupon the gum centers G adhere more easily to the inner fixed circumferential wall of the fixed tub 5 due to the viscosity of syrup. On the other hand, when the angle of the straight portion 22 is larger than 55°, the gum centers G have difficulty in going upward along the straight portion 22. The result is that the gum centers also adhere to the inner fixed circumferential wall of the fixed tub 5.

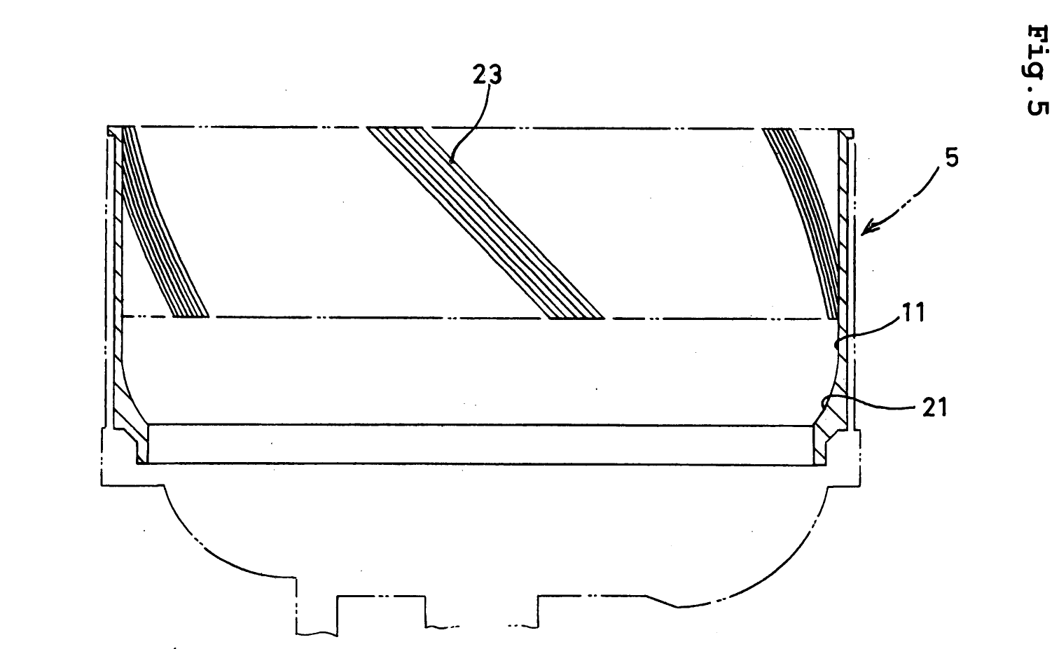

The polyurethane lining 11 applied to an upper portion of the inner fixed circumferential wall of the fixed tub 5 includes an adhesion preventing portion 23 (shown in FIG. 5) for inhibiting the gum centers G from adhering to the inner fixed circumferential wall of the fixed tub 5. The adhesion preventing portion 23 extends over the entire circumference of the fixed tub 5 and has a predetermined width (only representative streaks are shown in FIG. 5). The adhesion preventing portion 23 is composed of a plurality of protrusions, preferably a number of streaks or ridges made up of convex and concave portions extending in a flowing direction of the gum centers G as shown in FIG. 5. In this embodiment, the adhesion preventing portion 23 has an inclination of 45°.

The operation of the coating apparatus will now be described. Firstly, the coating tub 1 is inclined about the support shafts 2 and a predetermined amount of gum centers G are put into the coating tub 1. Subsequently, the coating tub 1 is returned to a horizontal attitude. When the drive motor 10 is energized, the rotational shaft 9 and the rotating plate 6 are rotated at high speeds. As a result, the gum centers G contained in the coating tub 1 start to flow (vortex motion). A suitable amount of gum syrup is repeatedly put into the coating tub 1 from above.

A preferable amount of gum centers G ranges from 10% to 80% of the capacity of the coating tub 1. The inventor has experimentally confirmed that the gum centers G are resistant to flow in the coating tub 1 when the amount of gum centers G are below 10% or above 80% of capacity. The experiments show that good fluidity can be achieved when the amount of gum centers G range from 30% to 60% of the capacity of the coating tub 1.

When the fluidity of the gum centers G is inspected in detail, the gum centers G are subjected to a force moving the gum centers G to the outer circumferential side due to the centrifugal force the gum centers G receive from the rotating plate 6. Accordingly, the gum centers G firstly move from the arc portion 20 of the rotating plate 6 to the straight portion 22, thereafter moving upward along the straight portion 22. The gum centers G then move to the transfer portion 21. A preceding gum center G is subjected to a pushing force from a following gum center G, thereby moving upward along the inner fixed circumferential wall of the fixed tub 5. The gum centers G move upward until the amount of movement diminishes and thereafter the gum centers G flow downward toward the center pole 17. The above-described flow cycle is subsequently repeated. Thus, the circulation of gum centers G is repeated with agitation.

The arc portion 20 and the transfer portion 21 are connected by the straight portion 22 which forms the tangential line to these portions 20 and 21. Consequently, the flowing speed of the gum centers G can be increased as compared to a case where the bottom of the coating tub has a uniform curvature radius without provision of the straight portion 22. This was confirmed by an experiment described later.

The gum centers G slide pass the adhesion preventing portion 23 when moving upward along the inner fixed circumferential wall of the fixed tub 5. Since a number of concave and convex streaks extend along the flowing direction of the gum centers G, the frictional resistance is reduced between the inner fixed circumferential wall of the fixed tub 5 and the gum centers G as compared with the case where no adhesion preventing streaks are provided. Accordingly, since the gum centers G are introduced to a higher position on the inner fixed circumferential wall of the fixed tub 5, the sliding distance of the gum centers G can be increased. In other words, the coating area for the gum centers, where the gum centers G are subjected to the coating material, can be increased and the drying area for the gum centers G, where the gum centers G are subjected to drying air, can also be increased.

Furthermore, typically when flowing downward to the central interior of the coating tub 1, the gum centers would be broken or cracked. However, the gum centers G flow while being in a line. Accordingly, even when the gum centers G has corners, as in this embodiment, the corners can be prevented from cracking. Additionally, the gum centers G may be more reliably prevented from being broken since polyurethane lining 11 is applied to the inner face of the coating tub 1.

The gum syrup supplied into the coating tub 1 is thinned by the gum centers G flowing in a vortex motion. Therefore, the gum syrup is able to spread more uniformly over the gum centers G.

Upon completion of the dropping or addition of the gum syrup, drying air from a heat source (not shown) is supplied through the duct 4. The vortex motion of the gum centers G coated with syrup is continued during the supply of the drying air. As a result, the drying air can be applied to the entire gum center G. The area where the gum centers G are falling from the upper portion of the fixed tub 5 to the center pole 17 is increased, as described above. Accordingly, a coating time and a drying time can be reduced because the coating area and drying area are increased. Further, the gum centers G, having been coated with syrup, flow or move at higher speeds than non-coated gum centers G. Accordingly, the friction between individual gum centers G is increased due to the increased speed. Frictional heat resulting from the increased friction between the gum centers enhances the drying of the syrup coatings.

Further, when the coating work is carried out repeatedly, small powder from the gum center G or residue of syrup remain on the bottom 5A. This is undesirable for sanitary reasons. In view of this problem, a blower (not shown) is usually connected to the drain hole 7 so that air is blown through a gap to prevent the residue from falling to the bottom 5A. A further measure is taken for dealing with the falling residue. When the center pole 17 is pulled by gripping the protrusion 18, the insertion shaft 24 is detached from the sleeve 25 of the lock bolt 16. Accordingly, the overall center pole 17 is removed from the stepped face 6A of the rotating plate 6. As a result, the portion of the rotating plate 6 around the connecting disc 15 is exposed and subsequently, the lock bolt 16 is loosened so as to be disengaged from the screw shaft 13. Thereafter, the rotating plate 6 can be detached from the fixed tub 5. Water cleaning is subsequently carried out so that gum and coating residue remaining on the bottom 5A is discharged through the drain hole 7.

When cleaning has been completed, the components are assembled in the reverse sequence from the sequence previously described. The coating tub is then ready for subsequent coating of additional gum centers G.

Experiment 1:

In experiment 1, the coating time was compared between the coating apparatus of the current invention (the coating apparatus of this embodiment, type number ECM200) and a foregoing pan coating apparatus (JP-U-45-2956-B). The same amount of gum centers was supplied to each of the coating apparatuses. The gum center used was generally square gum mainly comprising vinyl acetate and employing Arabic gum. The syrup used was comprised of a water solution of granulated sugar and 2 wt. % of gelatin. The room temperature was at 15° C. and the humidity was at about 50% during execution of coating.

Prior to the experiment, the maximum speeds were examined under the conditions where the coating tubs 1 were used without occurrence of breakage or crack in the gum centers G and the original flow was not prevented. The maximum speed was 98 rpm in the present invention, whereas it was about 17 rpm in the pan coating apparatus. The following TABLES show the results of the experiment. The required coating times of the present invention are listed in TABLE 1, and the required coating times of the convention pan coating apparatus are listed in TABLE 2.

TABLE 1

| | |
|---|---|
| Coating apparatus | ECM200 (with tub capacity of |
| | 200 liters) |
| Shape of gum center | Square 15 × 10 × 8 (mm) |
| Amount of gum center | 60 liters |
| Step | Syrup-drying |
| Rotational speed | 98 rpm |
| Required time | 4 to 5 minutes |

TABLE 2

| | |
|---|---|
| Coating apparatus | Pan coating apparatus (with tub |
| | capacity of 300 liters) |
| Shape of gum center | Square 15 × 10 × 5 (mm) |
| Amount of gum center | 60 liters |
| Step | Syrup-drying |
| Rotational speed | 17 rpm |
| Required time | 11 to 12 minutes |

As indicated by the tables, the required time in the coating apparatus of the embodiment was about one half of required time of the pan coating apparatus.

Experiment 2

In experiment 2, a comparison was made between the coating apparatus (the same as that used in experiment 1) of the present invention and the apparatus of JP-7-232049-A. The experimental manner was the same as that of experiment 1 except that the same rotational speed was used for each of the rotating plates. The time required for coating and drying of the gum centers G and the maximum height on the fixed tub 5 reached by the flowing gum centers G, were all measured. Also, the remaining amount of gum centers G adhered to the tub upon completion of the coating process was determined by inspection. TABLES 3 and 4 show the results of the measurements and inspections respectively for the invention and the apparatus of JP-7-232049-A.

TABLE 3

| | |
|---|---|
| Coating apparatus | ECM200 (with tub capacity of |
| | 200 liters) |
| Shape of gum center | Square 10 × 10 × 5 (mm) |
| Amount of gum centers | 50 liters |
| Step | Syrup-drying |
| Rotational speed | 98 rpm |
| Remaining amount | 0 |
| Required time | 4 to 5 minutes |
| Maximum point | 400 mm |

TABLE 4

| | |
|---|---|
| Coating apparatus | Apparatus of JP-7-232049-A (with |
| | tub capacity of 200 liters) |
| Shape of gum center | Square 15 × 10 × 5 (mm) |
| Amount of gum centers | 50 liters |
| Step | Syrup-drying |
| Rotational speed | 98 rpm |
| Remaining amount | 3 liters |
| Required time | 7 to 9 minutes |
| Maximum point | 330 mm |

In the coating apparatus of the invention, the centrifugal force and the pushing force effectively act on the gum centers G. The result of the forces improves the maximum height position obtained by the gum centers G. Accordingly, since the position where the gum center G starts sliding toward the center of the tub interior is relatively higher, the area thereof serving for contact with both the syrup and the drying air is increased. Consequently, the overall working time can be reduced.

Furthermore, when the gum centers G were discharged out of the coating tub upon the completion of the coating, no adherent gum centers G were found in the coating apparatus of the invention. However, gum centers amounting to approximately 3 liters were adherent to the inner fixed circumferential wall of the fixed tub of the apparatus of JP-7-232049-A. In the present invention, a number of concave and convex streaks are formed so that the contact resistance is reduced between the gum centers G and the inner fixed circumferential wall of the fixed tub. In the apparatus of JP-7-232049-A, no such streaks are found and the gum center pieces cause blocking and buildup on the tubwall. This maybe the cause for the adherence in the apparatus of JP-7-232049-A. Furthermore, the coating layers in the apparatus of JP-7-232049 were non-uniform. The coating layers had a smaller thickness in the adhered gum centers G than the coating layers in the normal or non-adhered gum centers G.

The invention should not be limited by the foregoing embodiment and may be modified as follows. The present invention may be applied to various types of coating, for example, the coating of candies, beans confectionary, chocolate, tablet confectionary, other foods, medicines, feed or the like. Furthermore, the object to be coated is not required to be square. Even when the object is spherical or has an unfixed shape, the coating can be carried out while the sphericity or original form is maintained. A spherical object is particularly apt to flow on the inner fixed circumferential wall of the fixed tub 5. Consequently, a further shortening of the work time can be expected for spherical gum centers.

The arc transfer portion is described as being only contained on the lower end of the inner fixed circumferential wall. The straight portion is described as being only contained on the inner rotating circumferential wall of the rotating plate. The dividing line between the fixed tub and the rotating plate can be moved from the location described with this embodiment. The location described is preferred.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

1. A coating apparatus comprising:
a cylindrical fixed tub including;
a bottom, and
an inner fixed circumferential wall including;
a lower end, and
an upper end;
a rotating plate rotatably mounted to the bottom of the fixed tub and including;
an inner rotating circumferential wall including;
a straight portion;
wherein the rotating plate is positioned coaxially with the fixed tub,
wherein the lower end of the inner fixed circumferential wall includes an arc transfer portion through which an object to be coated smoothly moves from the inner rotating circumferential wall toward and onto the upper end of the inner fixed circumferential wall,
wherein the inner rotating circumferential wall is continuous with the inner fixed circumferential wall, and
wherein the straight portion of the inner rotating circumferential wall has a linearly rising gradient toward the inner fixed circumferential wall.

2. The coating apparatus as claimed in claim 1, wherein the straight portion forms an angle ranging from 40° to 55° with a horizontal plane.

3. The coating apparatus as claimed in claim 2, wherein a lining of polyurethane resin is applied to surfaces of the inner fixed circumferential wall and the inner rotating circumferential wall.

4. The coating apparatus as claimed in claim 3, wherein the upper end of the inner fixed circumferential wall includes;
a circumferential adhesion preventing portion;
wherein the adhesion preventing portion inhibits objects from adhering to the inner fixed circumferential wall.

5. The coating apparatus as claimed in claim 4, wherein the adhesion preventing portion comprises a plurality of protrusions.

6. The coating apparatus as claimed in claim 5, wherein the plurality of protrusions are in the form of a plurality of ridges.

7. The coating apparatus as claimed in claim 6, wherein the plurality of ridges are oriented in a direction of flow of the objects to be coated.

8. The coating apparatus as claimed in claim 7, further comprising
a duct located over the interior of the rotating plate;
wherein the duct supplies drying air into the coating tub so that objects contained within the coating tub are dried.

9. The coating apparatus as claimed in claim 8, wherein the duct is located substantially over a rotational axis of the rotating plate.

10. A coating apparatus comprising:
a cylindrical fixed tub including;
a bottom, and
an inner fixed circumferential wall including;
a lower end, and
an upper end including;
an adhesion prevention portion comprising;
a plurality of ridges oriented in a flow direction of objects to be coated;
a rotating plate rotatably mounted to the bottom of the fixed tub and including;
an inner rotating circumferential wall including;
a straight portion;
wherein the rotating plate is positioned coaxially with the fixed tub,
wherein the lower end of the inner fixed circumferential wall includes an arc transfer portion through which an object to be coated smoothly moves from the inner rotating circumferential wall toward and onto the upper end of the inner fixed circumferential wall,
wherein the inner rotating circumferential wall is continuous with the inner fixed circumferential wall, and
wherein the straight portion of the inner rotating circumferential wall has a linearly rising gradient toward the inner fixed circumferential wall, and
wherein the straight portion of the inner rotating circumferential wall is represented by a line tangent to the arc transfer portion of the lower end of the inner fixed circumferential wall.

11. A coating apparatus comprising:
a cylindrical fixed tub including;
a bottom, and
an inner fixed circumferential wall including;
a lower end, and
an upper end including;
an adhesion prevention portion comprising;
a plurality of recesses oriented in a flow direction of objects to be coated;
a rotating plate rotatably mounted to the bottom of the fixed tub and including;
an inner rotating circumferential wall including;
a straight portion;
wherein the rotating plate is positioned coaxially with the fixed tub,
wherein the lower end of the inner fixed circumferential wall includes an arc transfer portion through which an object to be coated smoothly moves from the inner rotating circumferential wall toward and onto the upper end of the inner fixed circumferential wall,
wherein the inner rotating circumferential wall is continuous with the inner fixed circumferential wall, and
wherein the straight portion of the inner rotating circumferential wall has a linearly rising gradient toward the inner fixed circumferential wall, and
wherein the straight portion of the inner rotating circumferential wall is represented by a line tangent to the arc transfer portion of the lower end of the inner fixed circumferential wall.
